(19) United States
(12) Patent Application Publication
(10) Pub. No.: US 2006/0021435 A1
(43) Pub. Date: Feb. 2, 2006

(54) Sensor for measuring jerk and a method for use thereof

(75) Inventors: Rolf F. Orsagh, Rochester, NY (US); Douglas W. Brown, Rochester, NY (US)

Correspondence Address: BASCH & NICKERSON LLP, 1777 PENFIELD ROAD, PENFIELD, NY, 14526, US

(73) Assignee: Impact Technologies, LLC, Rochester, NY (US)

(21) Appl. No.: 11/191,114

(22) Filed: Jul. 27, 2005

Related U.S. Application Data
(60) Provisional application No. 60/591,389, filed on Jul. 27, 2004.

(51) Int. Cl. G01P 15/08

(52) U.S. Cl. 73/514.34

(57) ABSTRACT

Disclosed is a method and apparatus for measurement of the derivative of acceleration with respect to time (jerk) and the use of demodulation to analyze the jerk signal. The sensor used to measure jerk consists of a piezoelectric transducer coupled with an amplifier that produces a voltage or current signal that is proportionate to jerk. In applications including rolling element bearing diagnostics, demodulation is used to measure changes in the jerk signal over time.

This application claims priority from U.S. Provisional application No. 60/591,389, filed Jul. 27, 2004 by R. Orsagh et al., which is hereby incorporated by reference in its entirety.

This invention relates generally to vibration and shock analysis and more particularly to a method and sensor system for direct measurement of the physical quantity jerk and use of demodulation to analyze a jerk signal.

### BACKGROUND AND SUMMARY

Existing sensors for vibration analysis measure three physical quantities commonly used in Newtonian kinematics; position, the rate of position change (velocity), and the rate of velocity change (acceleration). Instruments for measuring position include proximity probes, which operate on the eddy current principle, capacitive sensors, and optical techniques. Velocity measurement devices include seismic pickups, which operate on the same principle as the electrodynamic microphone or speaker, and laser interferometry, which utilizes the Doppler shift principle. The most commonly measured quantity in vibration analysis, acceleration, is typically measured using an accelerometer based on the piezoelectric principle.

U.S. Pat. No. 4,420,123 to Fox et al. discloses a piezoelectric force sensor on a fiber optic cable tensioner in conjunction with a transresistance amplifier to measure the rate of tension change and therefore an indirect measurement of jerk. In U.S. Pat. No. 5,610,817 to Mahon et al. an analog electronic circuit is disclosed to calculate jerk by differentiation of the signal from an accelerometer. Mechanical systems for jerk measurement have also been investigated and published by Tsuchiya et al. and Fujiyoshi et al.

The International Organization for Standardization (ISO) Vibration and shock Vocabulary 2041 (1990) defines jerk as “A vector that specifies the time-derivative of acceleration.” In less mathematical terms, jerk is the rate of change of acceleration. The embodiments disclosed herein significantly extend the field of vibration analysis by providing simple low noise measurements of a physical quantity (jerk) that is better suited to examination of high frequency phenomena than the conventional vibration quantities of position, velocity and acceleration. The following disclosure includes a jerk measurement methodology, a sensor design, and demonstration of feasibility using established vibration testing techniques and prototype hardware.

As illustrated in FIG. 1, an accelerometer includes a transducer 100 consisting of a quartz or ceramic piezoelectric crystal 110 attached to a mass 112. As illustrated the transducer is operatively attached or coupled to a vibrating structure 120. As the device accelerates, the inertia of the mass applies a force (force=mass*acceleration) to the piezoelectric crystal, which generates a small electric charge (Q) proportionate to the applied force and to the acceleration (a) of the device as stated in Equation 1. Piezoelectric crystals typically produce relatively small quantities of charge (on the order of picoCoulmbs) that are difficult to measure without amplification.

A charge amplifier 130, as shown for example in FIG. 2, is typically used in accelerometers to convert the charge (signal) generated by the piezoelectric crystal to a voltage. This voltage is therefore proportionate to acceleration at frequencies well below the first natural frequency of the electromechanical system consisting of the inertial mass, piezoelectric crystal, and amplifier circuit.
α∝F∝Q Eq. 1

The present invention measures jerk using a piezoelectric crystal and mass as generally depicted in the configuration of FIG. 1 as an accelerometer, and a similar circuit to a charge amplifier shown in FIG. 2. However, the current invention is distinguished from an acceleration measurement system by the setting of the cutoff frequency of the resistor and capacitor combination in the amplifier above the maximum frequency of interest. Moreover, the amplifier may reside within the piezoelectric crystal packaging, as a modular inline device, or within an associated data acquisition system.

Disclosed in embodiments herein is a sensor for the measurement of a derivative of acceleration of a structure with respect to time comprising: a transducer, said transducer including a piezoelectric crystal operatively attached between the structure and an inertial mass, wherein the inertial mass applies a mechanical strain to the crystal which thereby generates an electrical signal; and a transresistance amplifier circuit, said circuit receiving the electrical signal and producing a voltage signal proportionate to the acceleration of the structure with respect to time.

Further disclosed in embodiments herein is a method for measuring acceleration of a structure with respect to time comprising: generating an electrical signal in response using a transducer, the transducer including a piezoelectric crystal operatively attached between the structure and an inertial mass, wherein the inertial mass applies a mechanical strain to the crystal; and converting the electrical signal to a voltage signal proportionate to the acceleration of the structure with respect to time using a transresistance amplifier.

Also disclosed in herein is a method of calibrating a jerk sensing system, comprising: using a transducer, generating a first electrical signal in response to a known acceleration; converting the first electrical signal to a first voltage signal proportionate to the acceleration of the structure with respect to time using a transresistance amplifier; measuring and storing a representation of the first voltage signal over time; and applying a linear regression of the measured signal versus an applied jerk amplitude calculated from the known acceleration to determine a calibration factor.

### BRIEF DESCRIPTION OF THE DRAWINGS

FIGS. 1 and 2 are illustrative examples of components of a prior art accelerometer, respectively a piezoelectric transducer and a simplified charge amplifier;

FIGS. 3 and 4 are illustrations of alternative circuit designs for use in accordance with the embodiment of FIG. 1 for sensing jerk;

FIGS. 5 and 6 are, respectively, pictorial and schematic illustrations of a prototypical embodiment in which components of a jerk sensor may be incorporated;

FIGS. 7 and 8, are, respectively, pictorial and schematic illustrations of an alternative, in-line embodiment in which components of a jerk sensor may be incorporated;

FIGS. 9-11 are charts illustrating various characterizations of exemplary signals output from a jerk sensor; and

FIG. 12 is a chart illustrating a raw and demodulated jerk signal derived from mounting a sensor on a rolling bearing test fixture.

### DETAILED DESCRIPTION

The disclosure will be characterized in connection with a preferred embodiment(s), however, it will be understood that there is no intent to limit the scope of the disclosure to the embodiment described. On the contrary, the intent is to cover all alternatives, modifications, and equivalents as may be included within the spirit and scope of the appended claims.

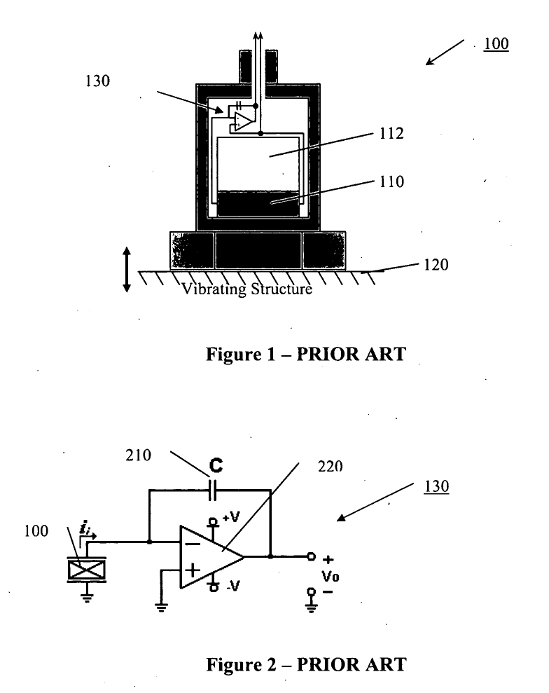

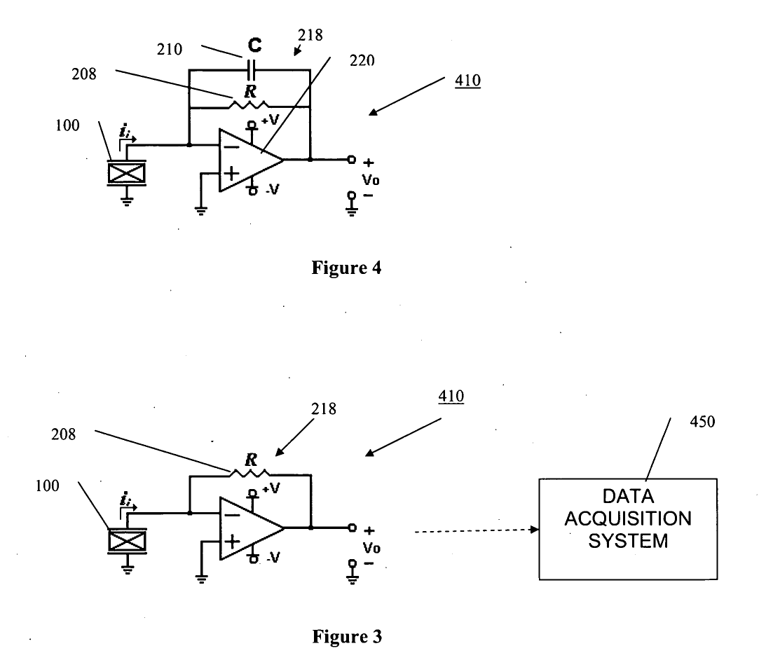

The following disclosure assumes familiarity with an accelerometer as set forth in general in FIGS. 1 and 2. In a general form, a sensor for the measurement of jerk (derivative of acceleration of a structure with respect to time) comprises a transducer such as transducer 100 in FIG. 1. The transducer includes a piezoelectric crystal 110 operatively attached between the structure 120 and an inertial mass 112, wherein the inertial mass applies a mechanical strain to the crystal which thereby generates an electrical signal. The sensor also includes a transresistance amplifier such as the amplifier circuit in FIG. 3, wherein the circuit receives the electrical signal and produces a voltage signal proportionate to the jerk of the structure with respect to time.

In the disclosed embodiment of FIG. 3, a capacitor 210 may be added in parallel with the resistor 208 to suppress high amplitude signals associated with the natural frequencies of the electromechanical system. An operational amplifier 220 with this capacitor and resistor combination in the feedback loop 218 has a frequency response given by Equation 2. At frequencies far above the −3 dB “cutoff frequency” defined by Equation 3, the voltage Vₒᵤₜ is approximately proportional to the integral of current I. At frequencies far below the cutoff frequency the voltage Vₒᵤₜ is proportional to the current I. This circuit is similar to the charge amplifier used for accelerometers, except that the cutoff frequency of the low pass filter in the feedback loop is preferably above the maximum frequency of interest (typically in the range of about 10 kHz to 100 kHz). Therefore, the current invention is distinguished from an accelerometer by selection of a resistor and capacitor combination that yields a cutoff frequency above the frequency range of interest as opposed to below the frequency range of interest. Additionally, the resistor value must be relatively large (tens of thousands of Ohms) to convert the relatively small current generated by the crystal into a readily measured voltage.

$$\begin{matrix}{V}_{out} = - I ( \frac{1}{\frac{1}{R} + jω C} ) & Eq . 2 \\ {f}_{c} = \frac{1}{2 π RC} & Eq . 3\end{matrix}$$

Higher order filters, comprising a network of capacitors 210 and resistors 208, may be used to achieve greater or steeper roll-off (attenuation as a function of frequency). Filters with eight or more poles may be used to increase the effective bandwidth of the sensor.

In accordance with the following disclosure, it is possible to measure the rate of acceleration change (jerk) using the same piezoelectric crystal and mass transducer configurations as accelerometers. Differentiation of Equation 1 with respect to time indicates that jerk (J) is proportional to the rate of charge generation by the crystal as shown in Equation 4. As noted above, one embodiment utilizes a transresistance amplifier, such as amplifier 410 as shown in FIG. 4, to convert the rate of charge production, or electric current, to a voltage that is readily measured. Although various currents may be produced, one embodiment contemplates currents in the range of about 4 to about 20 milliamps. The voltage output (Vₒ) from this amplifier is proportionate to the current (i) as stated in Equation 5 and is therefore proportionate to jerk (a rate of change in mechanical strain of the transducer). As illustrated in FIG. 4, the output voltage signal is provided to a data acquisition system 450 that should be capable of storage and, possibly, further processing of the output signals. An example of such a data acquisition system may be an analog to digital converter such as that produced by National Instruments.

$$\begin{matrix}jerk = \frac{ⅆ a}{ⅆ t} ∝ \frac{ⅆ Q}{ⅆ t} = i & Eq . 4 \\ {V}_{o} = - R * i & Eq . 5\end{matrix}$$

The characteristics of the jerk signal may be predicted for simple (single degree of freedom) vibrating systems. The acceleration (a) of many vibrating mechanical systems with respect to time (t) is approximately sinusoidal as stated in Equation 6, where A is the acceleration amplitude and f is the frequency of vibration. Differentiating Equation 6 with respect to time yields an expression for jerk of the system as stated in Equation 7. Note that the amplitude of the jerk signal is greater than that of the acceleration by a factor of 2πf and increases linearly with frequency (or 20 dB per Decade). Furthermore, note that the phase of the jerk waveform lags behind the acceleration by 90 degrees (or π/4 radians).
α=Asin(2πft) Eq. 6
J=2πfAcos(2πft) Eq. 7

Calibration of a jerk sensor such as those disclosed herein may be accomplished by applying Equation 7 to vibration with known acceleration amplitude over a range of frequencies. As a result, a constant of proportionality (i.e., calibration factor) for the sensor may be determined by linear regression of the jerk signal (voltage) versus the calculated jerk amplitude.

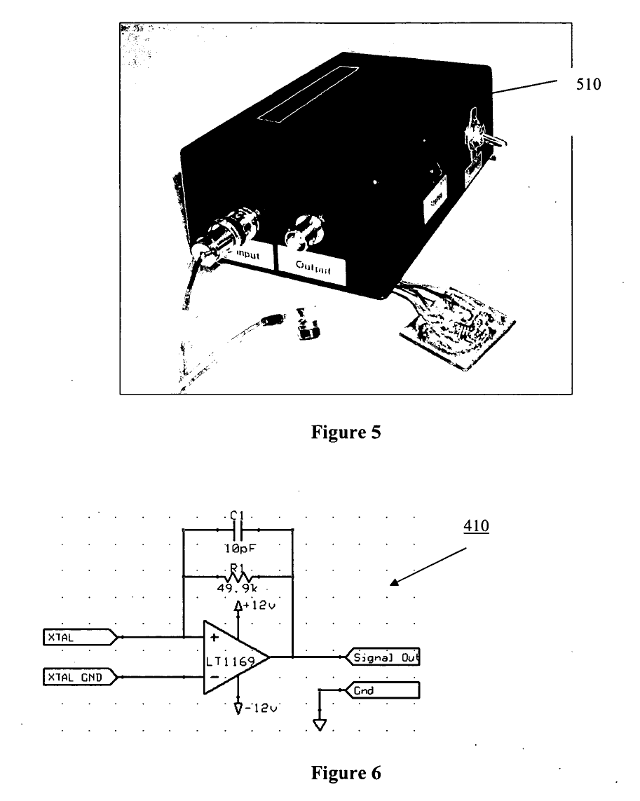

Referring also to FIG. 5, depicted therein is an exemplary embodiment of a sensor in accordance with the present disclosure. Due to the relatively weak signal generated by the piezoelectric crystal 110, the charge amplifier (e.g., transresistance amplifier 410) is preferably located in close proximity to the transducer, possibly within the same housing 510 as the crystal.

Power may be delivered to the active components (e.g., operational amplifier) using established standards for accelerometers. Example implementations of this standard include ICP® (PCB Piezotroinics), and Isotron® (Endevco). The operational amplifier receives power by means of a constant current over the same pair of leads that carry the output signal from the amplifier.

Amplitude demodulation (enveloping) is a signal processing technique that is commonly used in the analysis of acceleration signals. Amplitude demodulation may be achieved by means of an analog electronic circuit or digital signal processing. A variety of analog electronic circuits designed for band pass filters, half and full wave rectifiers, and low pass filters have proven effective at amplitude demodulation. Similarly, a variety of digital signal processing algorithms including filter-based enveloping (band pass filter, half and full wave rectifier, and low pass filter) and the Hilbert transform have proven effective at digital amplitude demodulation. Accordingly, the required amplitude demodulation may be accomplished in one of several ways, and may be somewhat dependent upon the particular application in which the jerk sensor is employed. It will be further appreciated that such processing may be performed by known signal processing devices or techniques on the data stored in the data acquisition system.

As illustrated in FIG. 5, a prototype circuit to demonstrate the jerk measurement system may be implemented as an inline system with a commercially available piezoelectric device intended for use as an accelerometer. In such a design, such as the schematic of FIG. 6, a JFET op-amp is well suited for use in low input current applications. Passive components include a 49.9 kΩ resistor, and a 10 pF capacitor which yield a cutoff frequency of 44 kHz.

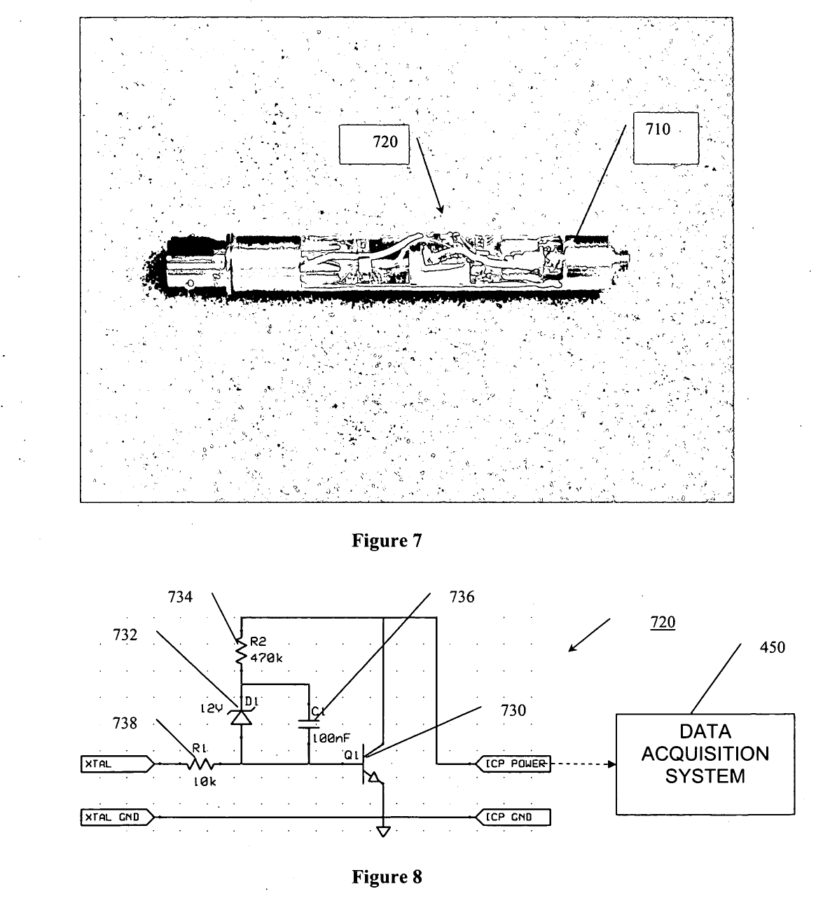

An inline version of the circuit of FIG. 6 is shown in FIGS. 7 and 8, respectively showing the physical and schematic representations. In the in-line sensor 710, the power to drive the associated circuit components may be provided by a constant current source (I_{bias}) using previously established standards (ICP®, Isotron®, etc.). The inline version 710 uses an identical architecture as the previous circuit with the exception of a smaller form factor capable of integration into a single piezoelectric package. Referring specifically to FIG. 8, the inline circuit 720 requires only five components: an NPN transistor 730, a zener diode 732, a feedback resistor 734 (Rf), a coupling capacitor 736, and a shunt resistor 738.

The key electrical characteristics of the inline sensor include the DC biasing point and the transresistance gain. The output bias voltage of the sensor (Equation 8) is dependent on six factors: transistor forward gain (β^{f}), biasing current (I_{bias}), thermal voltage (V_{T}), zener diode breakdown voltage (V_{Z}), feedback resistance (R_{f}), and the revere saturation current (I_{S}). The small signal gain of the sensor (Equation 9) is only dependent upon one factor, (R_{f}). The output voltage of the sensor is designed to operate within the limits of 0-30 volts. Therefore the selection of the optimal DC bias voltage is the midpoint between the lower and upper bounds of the output range: 15V. Provided the bias current ranges between 2 and 4 milliamps (mA), β_{f} is distributed normally between 200-800 V/V, and the gain set to about −470,000V/A, the optimal design allows for the bias voltage to deviate to within ±5V when (V_{Z}) and (R_{f}) are selected to 12V and 470 kΩ respectfully. This allows the output of the sensor to operate within a dynamic range of about ±10V about the DC bias voltage. The shunt resistor 738 is used to suppress the resonance of the piezoelectric crystal.

$$\begin{matrix}{V}_{bias} = {V}_{T} \cdot ln ( \frac{{I}_{bias}}{{I}_{s}} ) + {V}_{z} + \frac{{I}_{bias} {R}_{f}}{{β}_{f} + 1} & Eq . 8 \\ \frac{{v}_{out}}{{i}_{in}} = - {R}_{f} & Eq . 9\end{matrix}$$

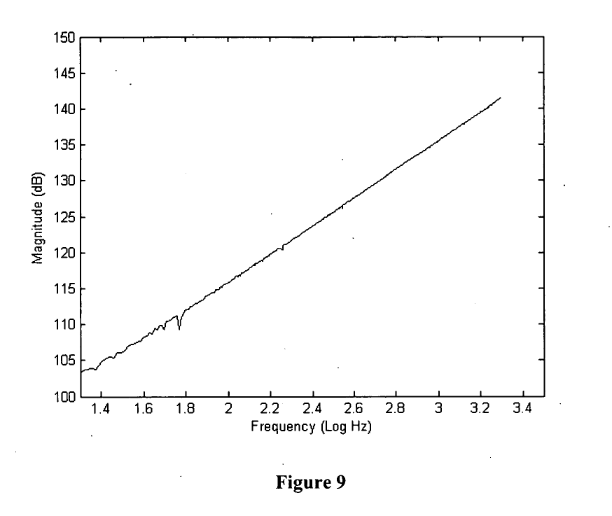

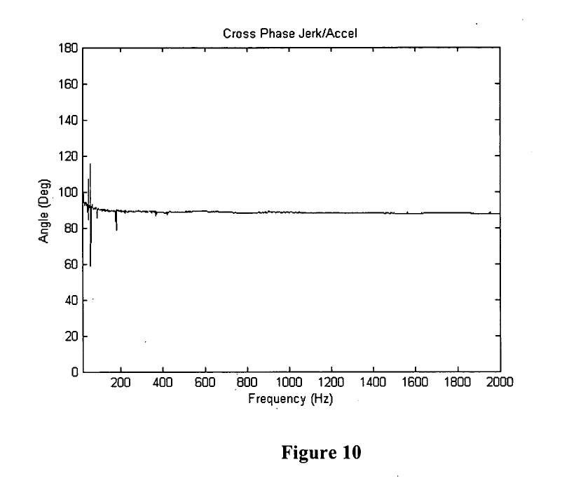

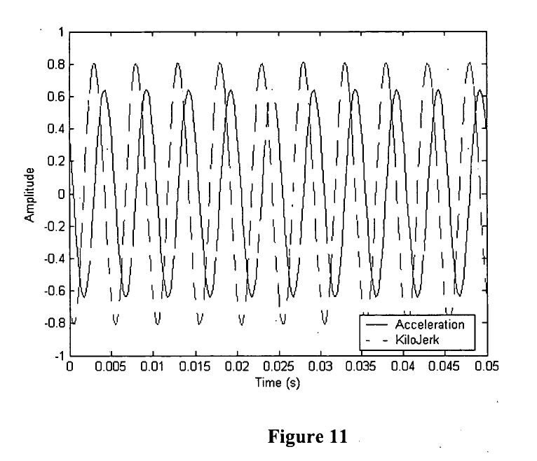

The properties of a prototype jerk sensor were demonstrated by mounting it on an electromagnetic shaker. A sinusoidal acceleration of constant amplitude over the frequency range from 10 to 1000 Hz was generated by the shaker and jerk and acceleration were measured simultaneously and used to compute the transfer function H1 (jerk/acceleration) and cross phase as shown in FIGS. 9-11. As expected from Equation 8, FIG. 9 illustrates that the amplitude of the jerk signal with respect to the acceleration signal increases with frequency at a rate of approximately 20 dB per decade. Furthermore, the phase of the jerk signal lags behind acceleration by 90 degrees (or π/4 radians) as depicted in the chart of FIG. 10.

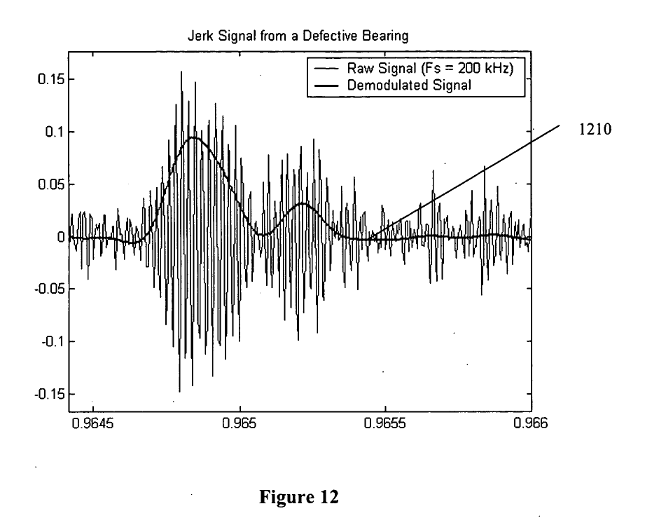

The prototype jerk sensor was used to collect vibration data from a rolling element bearing test rig. FIG. 12 shows the time-domain jerk signal that was sampled at 200 kHz. This signal was demodulated by applying a 40 kHz to 50 kHz Butterworth band-pass filter, squaring all of the values, applying a low pass Butterworth filter (with a cutoff frequency at 5 kHz), subtracting the mean from all values, and applying a scale factor for visualization. The modulation signal 1210 (shown in FIG. 12 as a continuous line) may be re-sampled at a frequency lower than the original signal (and greater than twice the low pass filter cutoff) to reduce processing and storage requirements. The modulation signal which represents the envelope (variation of the signal amplitude over time) is valuable for machinery diagnostics including detection and classification of rolling element bearing and gear faults.

Various applications for the afore-described jerk sensor and acquisition system are contemplated. In particular, although depicted as a vibrating structure in FIG. 1, it will be appreciated that various structures may be monitored (including detection and diagnostics) using the described sensor. In one application the structure may be a rolling element, where the sensor is used for the detection of rolling element bearing defects. In another application, the structure may be operatively associated or coupled to a gear train or similar assembly, where the sensor is employed for the detection of gear defects. It is also possible to employ the sensor with a structure subject to transient vibration or shock, where the resulting voltage signal is representative of the shock. Further contemplated is an application where the structure to which the transducer is attached is part or otherwise operatively associated with a mechanical linkage, wherein the sensor is employed for the characterization of mechanical linkage motion.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A sensor for the measurement of a derivative of acceleration of a structure with respect to time comprising:
a transducer, said transducer including a piezoelectric crystal operatively attached between the structure and an inertial mass, wherein the inertial mass applies a mechanical strain to the crystal which thereby generates an electrical signal; and
a transresistance amplifier circuit, said circuit receiving the electrical signal and producing a voltage signal proportionate to the acceleration of the structure with respect to time.

2. The sensor of claim 1, wherein the electrical signal is a current signal proportionate to a rate of change in acceleration of the transducer.

3. The sensor of claim 2, further comprising a current amplifier to convert the current signal generated by the transducer to a current signal that is proportionate to the physical quantity jerk.

4. The sensor of claim 3, wherein the current signal has a magnitude in the range of 4 to 20 milliamps (mA).

5. The sensor of claim 1, wherein the transresistance amplifier includes a capacitor in a feedback loop of the amplifier to form a low pass filter that attenuates signals at frequencies above a range of interest.

6. The sensor of claim 5, further including a network of resistors and capacitors in the feedback loop of the amplifier circuit to form a low pass filter with a steep roll-off.

7. The sensor of claim 1, wherein supply power is delivered to the sensor by a constant current applied over a common pair of leads that also carry the voltage signal.

8. The sensor of claim 1 wherein said transresistance amplifier is a component of a signal processing circuit and where said signal processing circuit is at least partially embedded in a housing of said piezoelectric transducer.

9. The sensor of claim 8, wherein said signal processing circuit is in-line between the transducer and a data acquisition system.

10. The sensor of claim 8 wherein said signal processing circuit is integrated with at least one additional circuit employed to perform an operation on said signal.

11. The sensor of claim 1, wherein the structure includes rotating components and where the sensor is employed for the detection of rolling element bearing defects.

12. The sensor of claim 1, wherein the structure is operatively associated with a gear assembly and where the sensor is employed for the detection of gear defects.

13. The sensor of claim 1, wherein the structure is subject to transient vibration, and the voltage signal is representative of the transient vibration.

14. The sensor of claim 1, wherein the structure is operatively associated with a mechanical linkage and where the sensor is employed for the measurement of mechanical linkage motion.

15. A method for measuring acceleration of a structure with respect to time comprising:
generating an electrical signal in response using a transducer, the transducer including a piezoelectric crystal operatively attached between the structure and an inertial mass, wherein the inertial mass applies a mechanical strain to the crystal; and
converting the electrical signal to a voltage signal proportionate to the acceleration of the structure with respect to time using a transresistance amplifier.

16. The method of claim 15, further comprising analyzing the voltage signal using a demodulation operation to identify changes in the amplitude of voltage signal over time.

17. A method of calibrating a jerk sensing system, comprising:
using a transducer, generating a first electrical signal in response to a known acceleration;
converting the first electrical signal to a first voltage signal proportionate to the acceleration of the structure with respect to time using a transresistance amplifier;
measuring and storing a representation of the first voltage signal over time; and
applying a linear regression of the measured signal versus an applied jerk amplitude calculated from the known acceleration to determine a calibration factor.

18. The method of claim 17, further comprising applying the calibration factor to a measured signal obtained from an applied jerk having unknown acceleration to adjust the measured signal

19. The method of claim 17, wherein said calibration is carried out using a known acceleration amplitude over a range of frequencies.
